(19) United States
(12) Patent Application Publication
(10) Pub. No.: US 2020/0088384 A1
(43) Pub. Date: Mar. 19, 2020

(54) ILLUMINATION DEVICE

(71) Applicants: LITE-ON ELECTRONICS (GUANGZHOU) LIMITED, GUANGZHOU (CN); LITE-ON TECHNOLOGY CORPORATION, Taipei (TW)

(72) Inventor: Tsan-Li CHIU, Taipei (TW)

(21) Appl. No.: 16/567,605

(22) Filed: Sep. 11, 2019

(30) Foreign Application Priority Data
Sep. 17, 2018 (CN) 201811081175.4

(51) Int. Cl. F21V 11/16; F21S 8/08

(52) U.S. Cl. CPC F21V 11/16; F21W 2131/103; F21S 8/086

(57) ABSTRACT

An illumination device including a lamp and a light shielding hood is provided. The lamp has a front lamp cover with a light exit surface. The light shielding hood at least partially covers the light exit surface for reducing the light energy emitted from the lamp, and has a transmittance less than a predetermined value.

This application claims the benefit of People's Republic of China application Serial No. 201811081175.4, filed Sep. 17, 2018, the subject matter of which is incorporated herein by reference.

### BACKGROUND OF THE INVENTION

### Field of the Invention

The invention relates in general to an illumination device, and more particularly to an illumination device with a light shielding hood.

### Description of the Related Art

The illumination device for night illumination, such as street light, wall light or outdoor searchlight, can be disposed on sidewalk or the sides of the road or the periphery of the buildings. Let the street light be taken for example. According to the road conditions, the illumination type, light intensity and color temperature of the street light need to be adjusted to meet the market demand. For example, for the same street light, the light intensity needs to be higher to increase the luminance in some lighting areas, and the light intensity needs to be lower to decrease the luminance in some other lighting areas.

Therefore, how to provide an illumination device capable of meeting all illumination conditions and market demand without changing the shape of the lamp has become a prominent task for the industries.

### SUMMARY OF THE INVENTION

The invention is directed to an illumination device capable of providing different illumination effects through the design of the light shielding hood at least partially covering the light exit surface of the lamp.

According to one embodiment of the present invention, an illumination device including a lamp and a light shielding hood is provided. The lamp has a front lamp cover with a light exit surface, and the light exit surface has an unexpected light exit area. The light shielding hood covers the unexpected light exit area for reducing the light energy of the lamp emitted from the unexpected light exit area, and has a transmittance less than a predetermined value.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B respectively are a schematic diagram of an illumination device according to an embodiment of the present invention before and after the installation of a light shielding hood.

FIG. 2 is a schematic diagram of an illumination device according to another embodiment of the present invention.

FIG. 3 is a schematic diagram of an illumination device according to another embodiment of the present invention.

FIG. 4 is a cross-sectional view of the illumination device on the X-Z plane according to an embodiment of the present invention.

FIG. 5 is a schematic diagram of a light passing through the fine structures.

FIG. 6 is a schematic diagram of fine structures on the X-Y plane according to an embodiment of the present invention.

FIG. 7 is a schematic diagram of fine structures according to another embodiment of the present invention.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention. Similar/identical designations are used to indicate similar/identical elements.

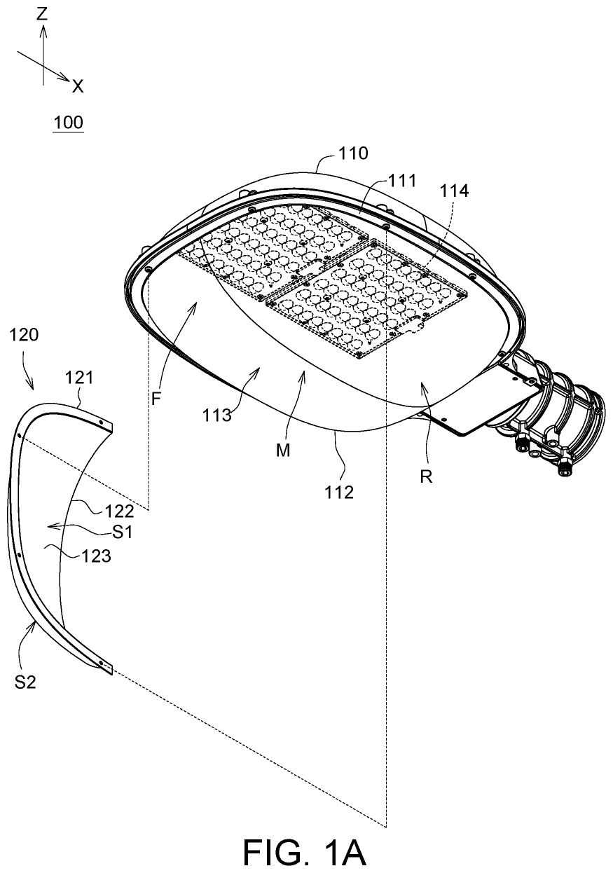

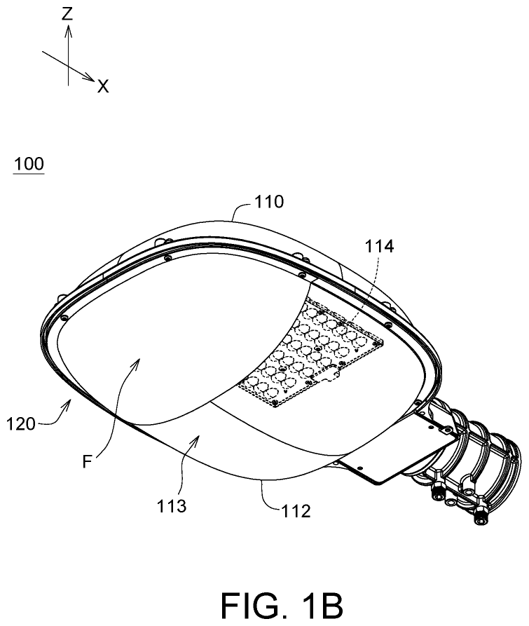

Refer to FIG. 1A and FIG. 1B. The illumination device 100 includes a lamp 110 and a light shielding hood 120. The lamp 110 has a front lamp cover 112 and a light-emitting element 114. The front lamp cover 112 has a light exit surface 113. The light shielding hood 120 at least partially covers the light exit surface 113 for reducing the light energy of the lamp 110 emitted from the unexpected light exit area or filtering a part of spectrum from the light, i.e., the transmittance of the light shielding hood 120 is less than a predetermined value. In general, the light-emitting element 114 is disposed in the lamp 110 and is protected by the front lamp cover 112. The light-emitting element 114 is normally disposed farther away from the front lamp cover 112. The light-emitting element 114 can be a light-emitting diode array element or other light source.

In an embodiment, the periphery 121 of the light shielding hood 120 and the periphery 111 of the lamp 110 are correspondingly coupled together for fixing the light shielding hood 120 on the lamp 110 by way of locking or engagement. In some embodiments, the inner surface S1 of the light shielding hood 120 and the light exit surface 113 of the front lamp cover 112 are coupled together. For example, the inner surface S1 can be adhered on the light exit surface 113 using an adhesive, or the inner surface S1 can be laminated on the light exit surface 113 by way of vacuum lamination. Preferably, the light shielding hood 120 and the front lamp cover 112 are completely sealed. More preferably, the light shielding hood 120 and the front lamp cover 112 are completely laminated to avoid moisture filtrating through the gap and leaving remnants in the gap.

The light shielding hood 120 can have an arced structure which matches the shape of the front lamp cover 112 (if the front lamp cover 112 is an arc), such that the shape of the light shielding hood 120 can match the shape of the light exit surface 113 of the front lamp cover 112 covered by the light shielding hood 120. In another non-illustrated embodiment, the light shielding hood 120 can be a plate-type structure whose shape matches the shape of the front lamp cover 112 (if the front lamp cover 112 is a plate).

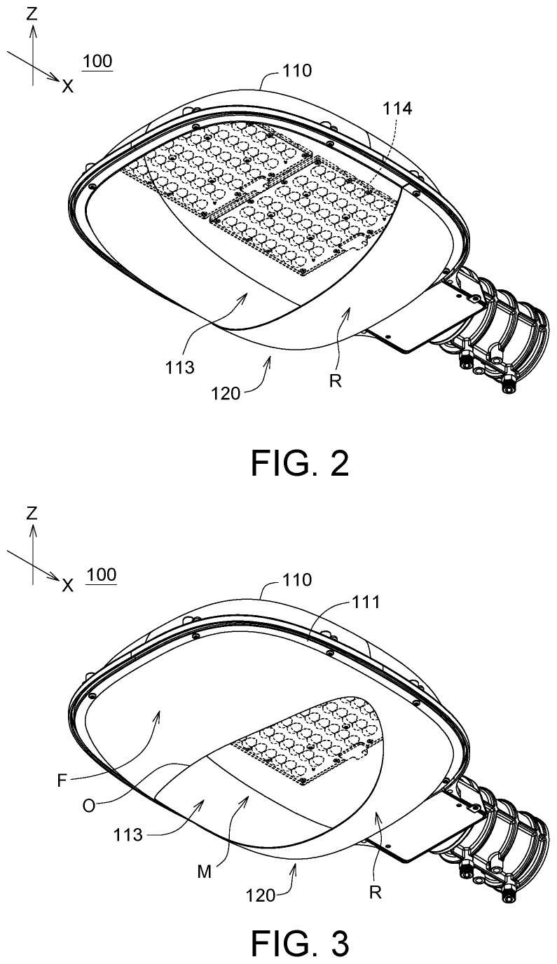

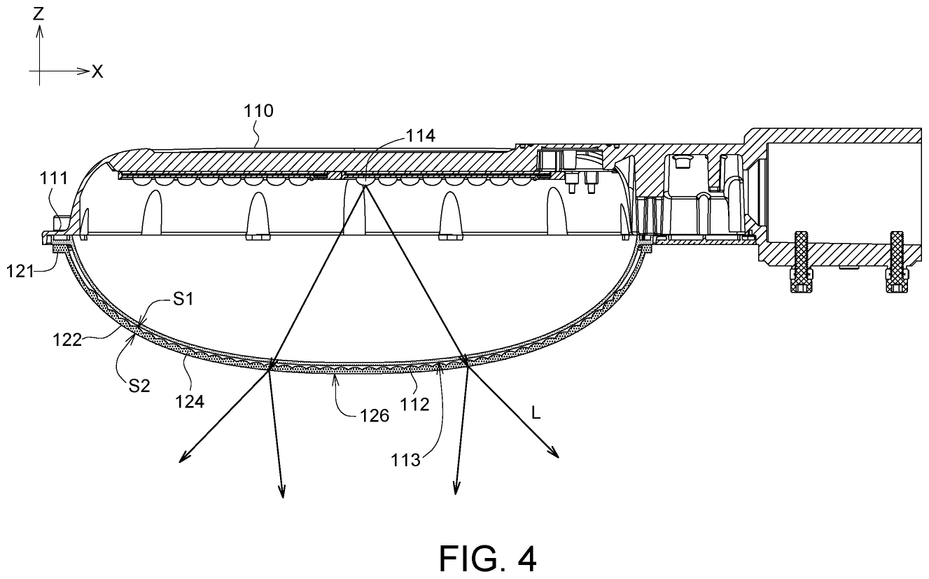

In an embodiment, the light shielding hood 120, based on the target illumination area for improvement, covers a part of the light exit surface 113, such as the front, the rear, or both the front and the rear of the light exit surface 113, for reducing the light energy emitted from the front and/or the rear of the light exit surface 113 or filtering a part of wave bands of the light. As indicated in FIG. 1B, the light shielding hood 120 covers a first light exit region F located at the front of the light exit surface 113. As indicated in FIG. 2, the light shielding hood 120 covers a second light exit region R located at the rear of the light exit surface 113. As indicated in FIG. 3, the center of the light shielding hood 120 has an opening O opposite to the central light exit region M of the lamp 110. The light shielding hood 120 covers the first light exit region F and the second light exit region R respectively located at the front and the rear of the light exit surface 113. The first light exit region F and the second light exit region R are located on two opposite sides of the central light exit region M of the lamp 110. Additionally, the light shielding hood 120 can completely cover the light exit surface 113 (as indicated in FIG. 4). Therefore, the area of the light exit surface 113 covered by the light shielding hood 120 can be adjusted to meet illumination conditions.

As indicated in FIG. 1B, 2 or 3, with the use of the light shielding hood 120, the light output at the front and/or the rear of the lamp 110 is less than the light output at the center of the lamp 110, such that the center of the lamp 110 has the highest illuminance to light up the road. Moreover, the front and/or the rear of the lamp 110 have lower illuminance, hence reducing light pollution or avoiding the stray light directly entering people's eyes and causing glare. Besides, the light shielding hood 120 is formed of a transmissive material instead of a metal or a material with high reflectivity, such that the light shielding hood 120 not only does not reflect the light back to the lamp 110. When the light is reflected to the lamp 110, the light energy will be converted into heat, which will be accumulated in the lamp 110 and cause high temperature and affect the performance of the lamp 110.

In an embodiment, the ratio of the light exit surface 113 covered by the light shielding hood 120 is between 5%-100%, preferably between 30%-80%, and more preferably between 40%-60%. The ratio can be adjusted according to actual situation. Moreover, the area of the first light exit region F of the light exit surface 113 covered by the light shielding hood 120 can be the same as or different from the area of the second light exit region R of the light exit surface 113 covered by the light shielding hood 120. For example, the area of the first light exit region F can be greater than or less than the area of the second light exit region R to adjust the light output type of the illumination device 100.

In an embodiment of the present invention, the light shielding hood comprises a casing and a dye. The casing is formed of a transmissive material and has an inner surface and an outer surface disposed oppositely. The dye is mixed in the casing, such that the transmittance of the light shielding hood is less than a predetermined value. In an embodiment, the casing 122 can be formed of a polymer material. For example, the casing 122 is formed of at least one of polycarbonate (PC), poly(methyl methacrylate) (PMMA), polymerized siloxanes (silicone), polystyrene (PS), polypropylene (PP), polyethylene (PE) and acrylonitrile butadine styrene (ABS). The casing 122 is recyclable and the hardness of the casing 122 is between 85 and 95 according to the Rockwell hardness test.

In the present embodiment, the casing 122 of the light shielding hood 120 contains the dye 123, such that the transmittance of the light shielding hood 120 is less than a predetermined value. For example, the transmittance of the light shielding hood 120 is between 50%-95%. That is, the dye 123 contained in the light shielding hood 120 can absorb or filter off a part of wave bands of the light to make the transmittance of the light shielding hood 120 less than a predetermined value. The transmittance of the light shielding hood 120 is inversely proportional to the concentration of the dye 123 doped in the light shielding hood 120. When the concentration of the dye 123 increases, the transmittance of the light shielding hood 120 decreases. In an embodiment, the concentration of the dye 123 contained in the casing 122 is less than or equivalent to 4% but greater than or equivalent to 0%. The concentration of the dye 123 contained in the casing 122 can be adjusted to meet illumination conditions, and is not limited to be less than or equivalent to 4%. Besides, the dye 123 contained in the casing 122 has a concentration variation. For example, the concentration of the dye 123 may gradually decrease from the periphery of the casing 122 to the central region of the casing 122, such that the transmittance of the casing 122 gradually increases from the periphery of the casing 122 to the central region of the casing 122. Or, the concentration of the dye 123 may gradually decrease towards a direction (such as a vertical direction or a horizontal direction). That is, the light shielding hood 120 can have a higher transmittance at a particular region to maintain a higher illuminance, and can have a lower transmittance at other regions to reduce light pollution.

In the present invention, the color of the dye 123 is not specified, and the dye 123 can be formed of an organic compound, such as (2-[[5-(2,4-Dichlorophenyl)furan-2-yl]methylene]-5-(4-methoxyphenyl)-7-methyl-3-oxygenation-5H-[1,3] thiazole-[3,2-a] pyrimidine-6-formic acid ethyl ester), ethyl 2-[[5-(2,4-dichlorophenyl) furan-2-yl] methylidene] -5-(4-methoxyphenyl)-7-methyl-3-oxo-5-[1,3] thiazole-[3,2-a] pyrimidine-6-carboxylate.

Moreover, the outer surface S2 of the light shielding hood 120 can be a smooth surface to avoid the contaminants being attached on the outer surface S2 of the light shielding hood 120. To increase the anti-contamination effect, a nano coating 126 can be formed on the outer surface S2 of the casing 122 (referring to FIG. 4). The nano coating 126 effectively isolates the oily and non-oily particulate contaminants of PM2.5 level, such that the nano coating 126 formed on the outer surface S2 achieves an anti-contamination effect and makes it difficult for the contaminants to be attached thereon. In an embodiment, the nano coating 126 can be a nano titanium dioxide-silicon dioxide photocatalyst film which can effectively decompose organic maters.

Apart from changing the transmittance using the dye 123, the light shielding hood 120 can change the light exit angle through a fine structure 124 disposed on the inner surface S1 of the casing 122 of the light shielding hood 120. Refer to FIG. 4. The fine structure 124 can be such as a lens array integrally formed on the inner surface S1 of the casing 122. In some embodiments, the inner surface S1 and the light exit surface 113 of the front lamp cover 112 are adjacent to each other and are separated by an interval, such that the air can be ventilated through the gap to dissipate the heat. In the present invention, the interval width preferably is less than the thickness of the light shielding hood to avoid external objects entering through the gap and leaving remnants therein.

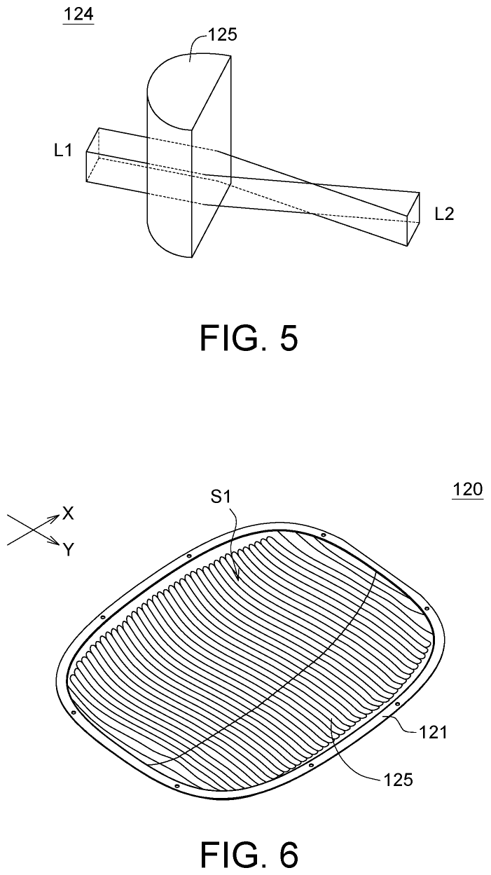

Refer to FIG. 5. After the light L1 passes through the fine structure 124, the light exit angle is changed, such that the light L1 proceeds towards different directions and become a divergent light L2. Therefore, as indicated in FIG. 4, the light exit angle of the light L of the light-emitting element 114 in the X-axis direction is enlarged, such that the light can be uniformly outputted via the fine structure 124.

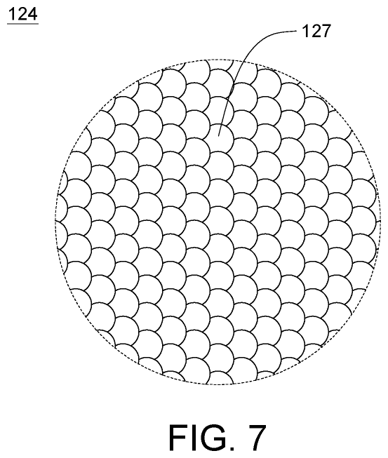

Refer to FIGS. 5 and 6. In an embodiment, the fine structure 124 may include a plurality of cylindrical lenses 125 whose length extends along the inner surface S1. The cylindrical lenses 125 are arranged as a bar in the direction of the short axis of the lamp 11 (that is, the Y-axis direction) and are arranged in parallel in the direction of the long axis of the lamp 110 (that is, the X-axis direction). Refer to FIG. 7. In another embodiment, the fine structure 124 may include a plurality of semicircular lenses 127 arranged on the inner surface S1 of the casing 122 to achieve an atomized or homogenized light output.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illumination device, comprising:
a lamp having a front lamp cover with a light exit surface, and the light exit surface having an unexpected light exit area; and
a light shielding hood covering the unexpected light exit area for reducing a light energy of the lamp emitted from the unexpected light exit area, wherein a transmittance of the light shielding hood is less than a predetermined value.

2. The illumination device according to claim 1, wherein the transmittance of the light shielding hood is less than a transmittance of the front lamp cover.

3. The illumination device according to claim 1, wherein the transmittance of the light shielding hood is between 50%-95%.

4. The illumination device according to claim 1, wherein above 5% of an area of the light exit surface is covered by the light shielding hood.

5. The illumination device according to claim 1, wherein the light shielding hood comprises a casing and a dye located inside the casing, the casing is formed of a transmissive material and has an inner surface and an outer surface disposed opposite to the inner surface.

6. The illumination device according to claim 5, wherein a concentration of the dye is between 0%-4%.

7. The illumination device according to claim 5, wherein the inner surface has a fine structure disposed thereon.

8. The illumination device according to claim 7, wherein the fine structure comprises a plurality of parallelly arranged cylindrical lenses whose length extends along the inner surface.

9. The illumination device according to claim 5, further comprising a nano coating formed on the outer surface of the casing.

10. The illumination device according to claim 5, wherein the inner surface and the light exit surface are adjacent to each other and are separated by an interval.

11. The illumination device according to claim 10, wherein a width of the interval is less than a thickness of the light shielding hood.

12. The illumination device according to claim 5, wherein the dye doped in the casing has a concentration change.

13. The illumination device according to claim 12, wherein the concentration of the dye in the casing gradually decreases towards a direction.

14. The illumination device according to claim 1, wherein the light shielding hood and the front lamp cover are coupled together.

15. The illumination device according to claim 1, wherein the light shielding hood and the front lamp cover are completely sealed.
